(19) United States
(12) Patent Application Publication
(10) Pub. No.: US 2016/0275589 A1
(43) Pub. Date: Sep. 22, 2016

(54) Filtering Product Reviews Based on Physical Attributes

(71) Applicant: TSA Stores, Inc., Englewood, CO (US)

(72) Inventor: Joseph Burke Newsum, Highlands Ranch, CO (US)

(21) Appl. No.: 14/661,732

(22) Filed: Mar. 18, 2015

(51) Int. Cl. G06Q 30/06; G06Q 30/02

(52) U.S. Cl. CPC G06Q 30/0627; G06Q 30/0282

(57) ABSTRACT

A method includes receiving a product review request from a user device to obtain one or more product reviews for a product or service being offered for sale by a retailer. The product review request includes an item identifier identifying the product or service. The method further includes obtaining user attribute information indicating one or more user physical attributes of the user and retrieving one or more associative product reviews for the product from non-transitory data storage based on the product review request and the user attribute information. The method further includes transmitting the one or more associative product reviews to the user device.

### TECHNICAL FIELD

This disclosure relates to product reviews for products or services being offered for sale by retailers and methods of providing product reviews to shoppers based on physical attributes of the shopper.

### BACKGROUND

Retailers can provide information about various products or services (including pictures, description, technical specifications, etc.) to shoppers over the internet. Retailers can further present to shoppers reviews from other shoppers related either to particular products or services. Shoppers often rely more on product reviewers from the other shoppers than any other source of information regarding a specific product.

However, product reviews are generally not organized and result in potential shoppers receiving product reviews from every shopper for the particular product or service. As a result, many of the product reviews provided to the potential shoppers are from other shoppers that have physical attributes or characteristics that are vastly different compared to those of the potential shopper, and therefore, many of the product reviews provided are not relevant to the particular product or service. For instance, providing a potential shopper with a product review for a shoe from another shopper having a narrow foot would not be relevant if the potential shopper has a wide foot. Thus, providing potential shoppers with product reviews from other shoppers having different physical attributes or characteristics consequently causes the potential shopper to rely on product reviews that may not be helpful when making a purchasing decision.

### SUMMARY

One aspect of the disclosure provides a review computing device receives a product review request from a user device to obtain one or more product reviews for a product or service being offered for sale by a retailer. The product review request includes an item identifier identifying the product or service. The review computing device obtains user attribute information indicating one or more user physical attributes of the user and retrieves one or more associative product reviews for the product from non-transitory data storage in communication with the review computing device based on the product review request and the user attribute information. The review computing device transmits the one or more associative product reviews to the user device.

Implementations of the disclosure may include one or more of the following optional features. In some implementations, each associative product review includes the item identifier and is associated with a reviewer including reviewer physical attributes that match the user physical attributes. In some examples, the review computing device receives the user attribute information from the user device when the product review request is received. The user attribute information may be manually input to the user device by the user. In other examples, the review computing device receives the user attribute information from an attribute input device when the product review request is received. The attribute input device may capture the user attribute information from the user. In some implementations, the attribute input device is selected from the group consisting of: a camera executing on the user device, a three-dimensional profiling device, and a three-dimensional motion device.

In some implementations, the review computing device receives a user identifier included with the product review request and retrieves the user attribute information from the data storage using the user identifier. In some examples, prior to receiving the product review request, the review computing device receives the user attribute information from an attribute input device, wherein the user attribute information is captured by the attribute input device. The review computing device may store the user attribute information in the data storage.

In some examples, the review computing device queries product reviews stored in the data storage using the item identifier and the user attribute information to identify which product reviews including the item identifier are associated with reviewers that include reviewer physical attributes matching the user physical attributes. Optionally, the review computing device may, prior to retrieving the one or more associative product reviews, identify the user attribute information as being relevant to the product associated with the product review request. In some implementations, the associative product reviews transmitted from the review computing device prompts an application executing on the user device to render the associative product reviews for display upon a user interface executing on the user device.

In some implementations, the review computing device receives a product review from a reviewer device that includes an item identifier identifying the product or service being reviewed. The review computing device may receive reviewer attribute information from an attribute input device, the reviewer attribute information corresponding to the reviewer creating the review. Additionally, the review computing device may obtain the reviewer physical attributes for the reviewer based on the reviewer attribute information and associate the product review with the reviewer physical attributes obtained for the reviewer. In some examples, the review computing device stores the product review associated with the reviewer physical attributes in the data storage.

In some examples the user physical attributes correspond to one or more static-based measurements associated with one or more body portions of the user. Additionally or alternatively, the user physical attributes correspond to one or more motion-based measurements associated with a prescribed movement of the user. Optionally, after obtaining the user attribute information, the review computing device may receive updated user attribute information from the user device indicating at least one of a new value or a range of values for the previously obtained user attribute information. Thereafter, the review computing device may retrieve one or more updated associative product reviews for the product from the data storage based on the product review request and the updated user attribute information and transmit the one or more updated associative product reviews to the user device.

Another aspect of the disclosure provides a remote system including one or more associative processing devices executing an associative service. The associative service receives a product review request from a user device to obtain one or more product reviews for a product or service being offered for sale by a retailer. The product review request includes an item identifier identifying the product or service. The associative service obtains user attribute information indicating one or more user physical attributes of the user and retrieves one or more associative product reviews for the product from non-transitory data storage in communication with the associative service based on the product review request and the user attribute information. The associative service transmits the one or more associative product reviews to the user device.

This aspect may include one or more of the following optional features. In some implementations, each associative product review includes the item identifier and is associated with a reviewer including reviewer physical attributes that match the user physical attributes. In some examples, the system further includes one or more attribute processing devices in communication with the one or more associative processing devices and executing an attribute service. The attribute service may receive the user attribute information from the user device when the product review request is received at the one or more associative processing devices. The user attribute information may be manually input to the user device by the user. In other examples, attribute service receives the user attribute information from an attribute input device when the product review request is received at the one or more associative processing devices. The attribute input device may capture the user attribute information from the user. In some implementations, the attribute input device is selected from the group consisting of: a camera executing on the user device, a three-dimensional profiling device, and a three-dimensional motion device.

In some implementations, the associative service, at the one or more associative processing devices, receives a user identifier included with the product review request and retrieves the user attribute information from the data storage using the user identifier. In some examples, prior to receiving the product review request at the one or more associative processing devices, the attribute service, at the one or more attribute processing devices, receives the user attribute information from an attribute input device, wherein the user attribute information is captured by the attribute input device. The review computing device may store the user attribute information in the data storage.

In some examples, the associative service, at the one or more associative processing devices, queries product reviews stored in the data storage using the item identifier and the user attribute information to identify which product reviews including the item identifier are associated with reviewers that include reviewer physical attributes matching the user physical attributes. Optionally, associative service may, prior to retrieving the one or more associative product reviews, identify the user attribute information as being relevant to the product associated with the product review request. In some implementations, the associative product reviews transmitted from the one or more associative processing devices to the user device prompts an application executing on the user device to render the associative product reviews for display upon a user interface executing on the user device.

In some implementations, the attribute service, at the one or more attribute processing devices, receives reviewer attribute information from an attribute input device, the reviewer attribute information corresponding to the reviewer creating the review. The associative service, at the one or more associative processing devices, may receive a product review from a reviewer device that includes an item identifier identifying the product or service being reviewed, obtain the reviewer physical attributes for the reviewer based on the reviewer attribute information and associate the product review with the reviewer physical attributes obtained for the reviewer. In some examples, the associative service, at the one or more associative processing devices, stores the product review associated with the reviewer physical attributes in the data storage.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for providing a user device access to product reviews filtered according to reviewer physical attributes.

FIG. 2 is a schematic view of example components of the system of FIG. 1.

FIG. 3 is a schematic view of an example user device in communication with a review service of FIG. 1.

FIG. 4 is a schematic view of example components of the system of FIG. 1 for storing product reviews associated with reviewer physical attributes.

FIG. 5 is a schematic view of example operations performed by the review service of FIG. 2.

FIG. 6 is a schematic view of example operations performed by the review service of FIG. 4.

FIG. 7 is a schematic view of an example review computing device of FIGS. 1-4.

FIG. 8 is a flowchart of an example method for transmitting product reviews filtered according to physical attributes of users to a user device.

Like reference symbols in the various drawings indicate like elements.

### DETAILED DESCRIPTION

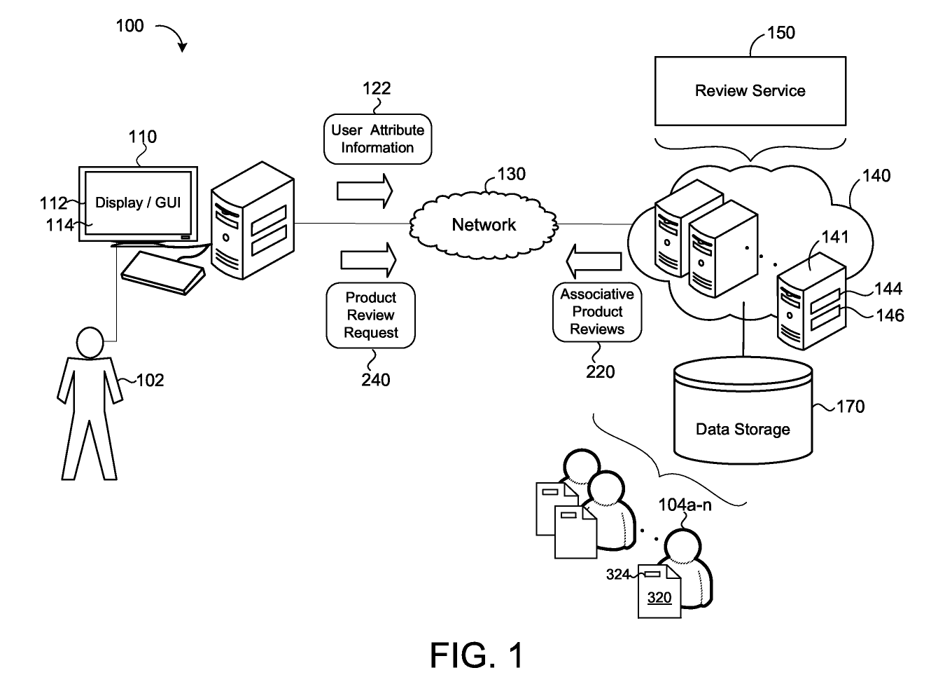

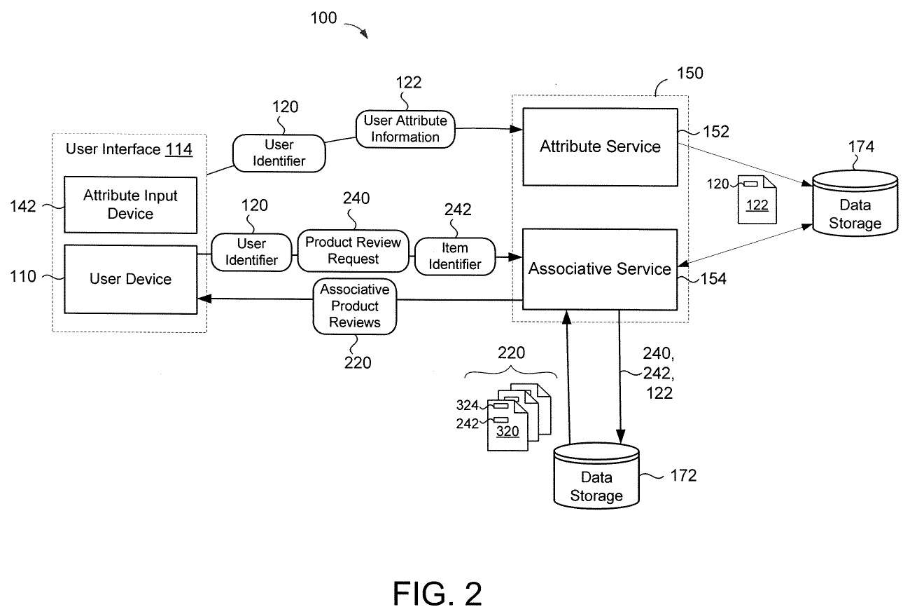

Referring to FIGS. 1 and 2, in some implementations, a system 100 includes a user 102 associated with a user device 110 executing a user interface 114 on a display 112. In some examples, the user interface 114 is a graphical user interface and communicates with an attribute input device 142. The user device 110 is in communication, via network 130, with a remote system 140. The remote system 140 may be a distributed system (e.g., cloud environment) having scalable/elastic resources 141. The resources 141 may include computing resources 144 and/or storage resources 146.

In some implementations, the remote system 140 executes a review service 150 that transmits one or more associative product reviews 220 to the user device 110 in response to receiving a product review request 240 from the user device 110. The product review request 240 may correspond to a request to obtain one or more product reviews for a product or service being offered for sale by a retailer. For instance, the product review request 240 may include an item identifier 242 that identifies a particular product or service the user 102 desires to obtain associative product reviews 220 for. As used herein, the term “product review” refers to a reviewer's subject opinions regarding the item (product or service) and its features and/or a rating given as part of the review to indicate the item's relative merit, e.g., by giving the reviewed item three stars within a range from zero stars (worst) to five stars (best). In some examples, the remote system 140 communicates with non-transitory data storage 170. The data storage 170 may collectively include data storage 172, 174 and 176, described in further detail below with reference to FIGS. 2-4. The data storage 172 may store a plurality of product reviews 320 each associated with reviewer physical attributes 324 corresponding to a reviewer 104a-n who created the review 320. Each product review 320 may be associated with a an item identifier identifying a particular product or service that the product review 320 associates with. The network 130 may include various types of networks, such as a local area network (LAN), wide area network (WAN), and/or the Internet.

Although the network 130 may represent a long range network (e.g., Internet or WAN), in some implementations, the network 130 includes a shorter range network, such as a local area network (LAN). In some implementations, the network 130 uses standard communications technologies and/or protocols. Thus, the network 130 can include links using technologies, such as Ethernet, Wireless Fidelity (WiFi) (e.g., 802.11), worldwide interoperability for microwave access (WiMAX), 3G, Long Term Evolution (LTE), digital subscriber line (DSL), asynchronous transfer mode (ATM), InfiniBand, PCI Express Advanced Switching, etc. Similarly, the networking protocols used on the network 130 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 130 can be represented using technologies and/or formats including the hypertext markup language (HTML), the extensible markup language (XML), etc. In addition, all or some of the links can be encrypted using conventional encryption technologies, such as secure sockets layer (SSL), transport layer security (TLS), virtual private networks (VPNs), Internet Protocol security (IPsec), etc. In other examples, the network 130 can use custom and/or dedicated data communications technologies instead of, or in addition to, the ones described above.

Referring to FIG. 2, a schematic view of example components of the system 100 of FIG. 1 are shown. In some examples, the user interface 114 executing on the user device 110 communicates with the attribute input device 142, while the review service 150 executes an attribute service 152 and an associative service 154. In some implementations, the associative service 154 receives the product review request 240 from the user device 110, obtains user attribute information 122 indicating one or more user physical attributes of the user 102, retrieves one or more associative product reviews 220 for the product from the non-transitory data storage 172 based on the user attribute information 122 and the product review request 240, and transmits the one or more associative product reviews 220 to the user device 110.

In some implementations, the user attribute information 122 is manually input to the user device 110 by the user 102 through the user interface 114 and transmitted from the user device 110 to the attribute service 152 when the product review request 240 is received by the associative service 154 or during a prior transaction that is separate from the transaction associated with the product review request 240. For instance, the user 102 may specify pertinent user attribute information 122 known by the user 102, such as, but not limited to, foot size and width, height, and weight. The attribute service 152 may additionally receive a user identifier 120 identifying the user 102 and store the user attribute information 122 associated with the user identifier 120 within the data storage 174.

In other implementations, the attribute input device 142 captures the user attribute information 122 and transmits the user attribute information 122 to the attribute service 152. In some examples, the attribute input device 142 provides the attribute information 122 to the user device 110 such that the user device 110 transmits the user attribute information 122 to the attribute service 152. The attribute service 152 may additionally receive the user identifier 120 identifying the user 102 and store the user attribute information 122 captured by the attribute input device 142, and associated with the user identifier 120, within the data storage 174. In some examples, the attribute input device 142 is managed by a retailer and located at a kiosk within a facility managed by the retailer. In other examples, the attribute input device 142 corresponds to hardware associated with the user 102 that is implements with software to capture and process the user attribute information 122.

In some examples, the attribute input device 142 is a camera executing on the user device 102. Here, the user device 110 may be a mobile computing device such as a smart phone or tablet. For instance, the user 102 may capture an image of the user's foot to indicate user attribute information 122 corresponding to the user's foot size or the user may capture video of the user 102 swinging a bat to indicate user attribute information 122 corresponding to the user's bat swing speed. In other examples, the attribute input device 142 is a three-dimensional profiling device. Three-dimensional profiling devices capture images of the user 102 and process three-dimensional data to indicate physical attributes of the user 102. The physical attributes of the user 102 can be static-based and/or motion based. For instance, the three-dimensional profiling device could capture an image of the user 102 and determine the user's height, arm length, and/or wing span. In other examples, the attribute input device 142 is a three-dimensional motion device capable of capturing an image of the user 102 and determining gestures made by the user 102. For instance, the three-dimensional motion device may determine a golf swing speed of the user 102 by capturing the user 102 practice swinging a golf club. This disclosure is not limited to any one specific type of user attribute device 142, and may include any user attribute device 142 capable of capturing user attribute information 122.

In some implementations, the associative service 154 receives the user identifier 120 included with the product review request 240. Using the user identifier 120, the associative service 154 may retrieve the user attribute information 122 from the data storage 174 in communication with the associative service 154 and the attribute service 152. Thus, the user attribute information 122 need not be provided from the user interface 114 simultaneously with the product review request 240 and may be provided during some early transaction with the attribute service 152 and stored within the data storage 174.

The associative service 154 may retrieve one or more associative product reviews 220 for the product or service from the data storage 172 based on the product review request 240 and the user attribute information 122. In some examples, the product review request 240 includes an item identifier 242 identifying the particular product or service.

In some implementations, the associative service 154 queries the plurality of product reviews 320 each associated with reviewer physical attributes 324 stored within the data storage 172 using the item identifier 242 and the user attribute information 122 to determine which product reviews 320 including the item identifier 242 are associated with reviewers 104 including reviewer physical attributes 324 matching the user physical attributes (e.g., user attribute information 122). In the example shown, a plurality of product reviews 320 including the item identifier 242 and the matching reviewer physical attributes 324 are identified and correspond to the associative product reviews 220. Accordingly, the associative service 154 retrieves the associative product reviews 220 from the data storage 172 and transmits the associative product reviews 220 to the user device 110.

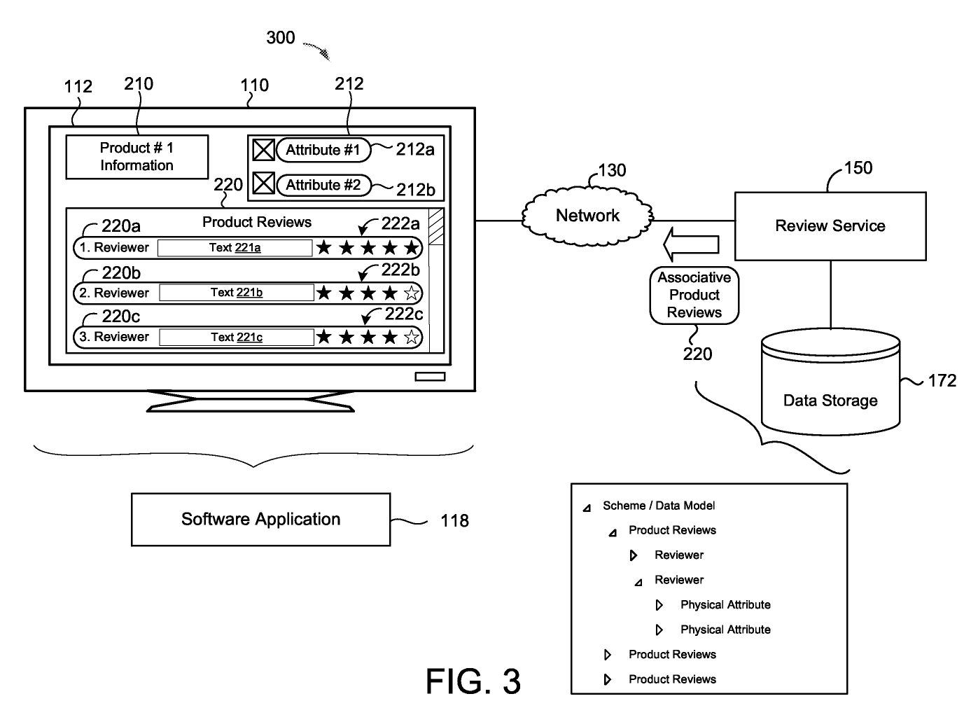

FIG. 3 shows a schematic view 300 of an example user device 110 in communication with the review service 150. User devices 110 can be any computing devices that are capable of communicating with the review service 150. While the example shows the user device 110 including a personal computing device, user devices 110 include, but are not limited to, mobile computing devices, such as laptops, tablets, smart phones, and wearable computing devices (e.g., headsets and/or watches). Additionally, the user device 110 may include a kiosk computing device within a facility managed by a retailer offering products for sale and providing the associative product reviews 220 to the user device 110. In some examples, the kiosk computing device may implement both the user device 110 and the attribute input device 142. In some implementations, the data storage 172 includes a schema arranging the associative product reviews 220 in a hierarchical structure. For example, a parent object indicative of a product review for a particular product or service may include a plurality of child objects each indicative of a reviewer who has submitted a product review for the particular product or service. Each reviewer may include a plurality of child objects each indicative of a physical attribute that the reviewer possess. Using the product review request 240 and the user attribute information 122, the review service 150 may query the data storage 172 to retrieve the associative product reviews 220.

The user device 110 may execute one or more software applications 118. A software application 118 may refer to computer software that, when executed by a computing device, causes the computing device to perform a task. In some examples, the software application 118 may be referred to as an “application”, an “app”, or a “program”. Example software applications 118 include, but are not limited to, word processing applications, spreadsheet applications, messaging applications, media streaming applications, social networking applications, and games.

Applications 118 can be executed on a variety of different user devices 110. In some examples, applications 118 are installed on the user device 110 prior to the user 102 purchasing the user device 110. In other examples, the user 102 may download and install applications 118 on the user device 110. In some examples, applications 118 may be a web service maintained by the retailer and accessible to the user device 110.

In some implementations, the user device 110 executes a product review application 118 that transmits the product review request 240 to the review service 150. In response to receiving the product review request 240, the review service 150 may obtain and transmit the associative product reviews 220 to the user device 110 through the network 130.

In some implementations, the product review application 118 renders the associative product reviews 220 for display upon the user interface 114 executing on the user device 110 when the review service 150 transmits the associative product reviews 220 to the user device 110 through the network 130. In the example shown, the associative product reviews 220 displayed upon the user interface 114 of the user device 110 include a set of associative product reviews 220a, 220b, and 220c each indicating a review for a product (e.g., Product #1) or service being offered for sale by the retailer and associated with a corresponding Reviewer 1, 2, and 3, respectively, including reviewer physical attributes 324 matching the user physical attributes 122. Each associative product review 220a, 220b, and 220c includes descriptive text 221a, 221b, and 221c, respectively, and/or a rating 222a, 222b, and 222c, respectively. In some examples, a graphical element is displayed for each associative product review 220a, 220b, and 220c, allowing the user 102, via a user input, to select one of the reviews 220a, 220b, or 220c to attain additional information, such as to read the entire review created by the given Reviewer 1, 2, or 3. In the example shown, the user 102 may scroll to view additional associative product reviews 220.

Moreover, upon receiving the associative product reviews 220 at the user device 110, the product review application 118 may render product information 210 and attribute information 212 for display upon the user interface 114. The product information 210 may include descriptive text describing the features of the product, use of the product, and price information for the product.

The attribute information 212 may include one or more physical attributes, e.g., “Attribute #1” and “Attribute #2”, pertaining to physical attributes that are possessed by each of the Reviewers 1, 2, and 3. In the example shown, the user 102 may scroll to view additional physical attributes. In some examples, the attribute information 212 is populated by the review service 150 based upon the user attribute information 122 corresponding to the physical attributes of the user 102. Additionally or alternatively, the review service 150 may first identify user attribute information 122 that are relevant to the product or service of interest when selecting what attributes are populated in the attribute information 212. For instance, the user 102 seeking product reviews for a ski boot would not benefit from filtering out product reviews 320 associated with reviewers who have a fast golf swing speed. In some implementations, each physical attribute, e.g., “Attribute #1” and “Attribute #2”, is selectable for inclusion in the associative product reviews 220. For example, an “X” denotes that a given physical attribute pertains to all the associative product reviews 220a, 220b, and 220c being displayed upon the user interface 114 while product reviews 320 not pertaining to the given physical attribute are effectively filtered out from being displayed upon the user interface 114. In the example shown, the Reviewers 1, 2, and 3 all possess physical attributes pertaining to “Attribute #1” and “Attribute #2”. The user 102 may, however, unselect one or more physical attributes within the attribute information 212 such that the displayed associative product reviews 220 may be updated to include additional associative product reviews 220 that were previously filtered out when the physical attribute was previously selected. Accordingly, the set of associative product reviews 220 may dynamically change based upon physical attributes within the attribute information 212 being selected/applied or unselected/ removed. Thus, the user 102 may manually input user attribute information 122 as described above through selecting attributes from a list displayed within the attribute information 212.

In some implementations, each physical attribute within the attribute information 212 is associated with a graphical element, e.g., a button, such that the user 102 may edit the attribute information 212 used for filtering the associative product reviews 220. In the example shown, “Attribute #1” is associated with graphical element 212a and “Attribute #2” is associated with graphical element 212b. Through a user input via a mouse, stylist, or touching, the user 102 may select one of the graphical elements 212a or 212b. Editing attribute information 212a and/or 212b may include changing a value for a given attribute or defining a range of values for the given attribute. For example, if “Attribute #1” pertains to a shoe size equal to Men's Size 8.5, the user 102 may select graphical element 212a to define a range of shoe sizes equal to Men's Size 8.0 to 9.0 or change the shoe size to now be equal to Men's Size 9.0. Thus, the review service 150 may receive updated user attribute information 122 from the user device 110 indicating one or more new values or a range of values for the previously obtained user attribute information 122. Thereafter, the review service 150 (e.g., the associative service 154) may retrieve updated associative product reviews 220 based on the product review request 240 and the updated user attribute information 122, and transmit the updated associative product reviews 220 to the user device 110 for display upon the user interface 114. The updated associative product reviews 220 may include additional or fewer product reviews based upon the updated user attribute information 122. Accordingly, in the above example, the review service 150 may provide a new set of associative product reviews 220 associated with reviewers having shoe size equal to and including shoe sizes between 8.0 and 9.0 or reviewers having the show size equal to Men's 9.0.

In some implementations, the user physical attributes 122 and reviewer physical attributes 324 correspond to one or more static-based measurements associated with one or more body portions of the user or reviewer. A static-based measurement may correspond to any measurable portion of the user's or reviewer's body. The static-based measurement may further correspond to a size, fit, specification or geometry associated with a specific activity based one any combination of measurable portions of the user's or reviewer's body. For instance, based on at least a torso measurement (e.g., torso length) and a leg measurement (e.g., leg length) of the user, an appropriate fit, size and/or geometry of a bike can be determined for the user. Non-limiting examples of user physical attributes 122 and reviewer physical attributes corresponding to static-based measurements associated with one or more body portions of the user or reviewer include foot size, a foot width, a wing span, a pant size, a shirt size, a height, a weight, a bike size, or a ski size. In some implementations, the user physical attributes 122 and reviewer physical attributes 324 additionally or alternatively correspond to a dominant hand, endurance information, speed information, or strength information. Endurance information may include, but is not limited to, times for running, biking, skiing, or swimming a specified distance. Speed information may include, but is not limited to, speeds for running, biking, skiing, or swimming a specified distance. Additionally or alternatively, in some implementations, the user physical attributes 122 and reviewer physical attributes 324 correspond to one or more motion-based measurements associated with a prescribed movement of the user or reviewer. A prescribed movement refers to a movement by the user or reviewer prescribed for a defined activity. For example, a golf swing is associated with a prescribed movement for hitting a golf ball with a golf club, whereas a kicking profile is associated with a prescribed movement for kicking a football or a soccer ball. Accordingly, motion-based measurements refer to measurements quantified during the prescribed movement by the user or reviewer. For instance, a swing speed, a down-swing acceleration and a swing plane angle may indicate measurements capable of being quantified when the user or reviewer swings a golf club. Non-limiting examples of user physical attributes 122 and reviewer physical attributes 324 corresponding to one or more motion-based measurements associated a prescribed movement of the user or reviewer include a golf swing speed, a golf swing angle, a golf swing profile, a bat swing speed, a bat swing angle, a bat swing profile, an archery draw weight, a throwing velocity, and a shot velocity.

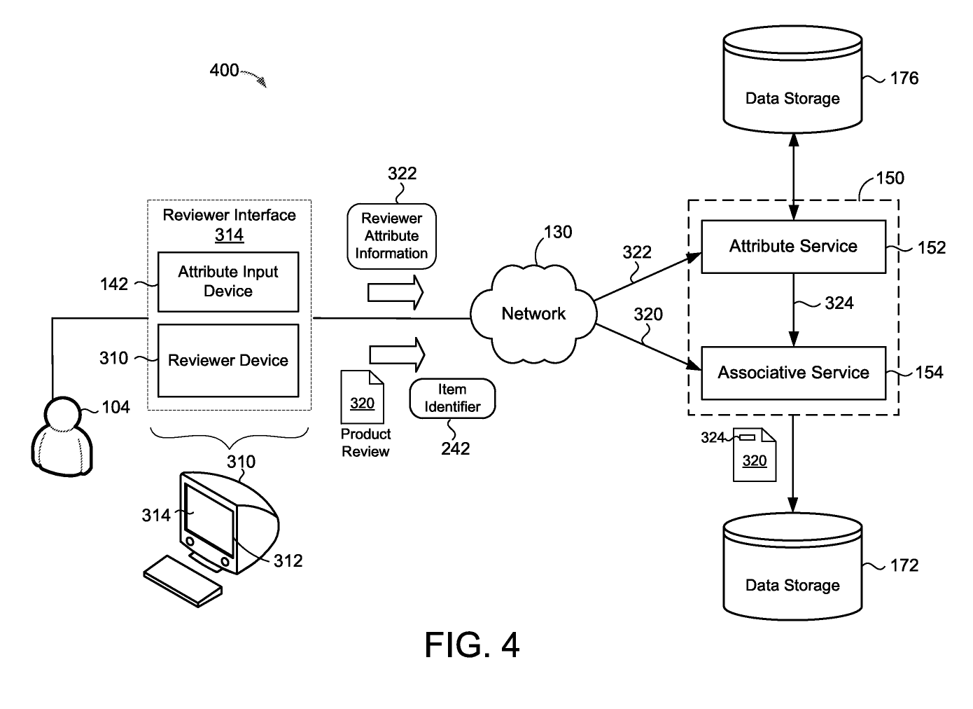

FIG. 4 is a schematic view 400 of example components of the system 100 of FIG. 1 for storing product reviews associated with reviewer physical attributes. In some implementations, a reviewer 104 is associated with a reviewer device 310 executing a reviewer interface 314 on a display 312. In some examples, the reviewer interface 314 is a graphical user interface and communicates with the attribute input device 142. The reviewer device 310 is in communication, via the network 130, with the review service 150 executing the attribute service 152 and the associative service 154.

Reviewer devices 310 can be any computing devices that are capable of communicating with the review service 150. While the example shows the reviewer device 310 including a personal computing device, reviewer devices 310 include, but are not limited to, mobile computing devices, such as laptops, tablets, smart phones, and wearable computing devices (e.g., headsets and/or watches). Additionally, the reviewer device 310 may include a kiosk computing device within a facility managed by a retailer offering products for sale and providing the associative product reviews 220 to the reviewer device 310. In some examples, the kiosk computing device may implement both the reviewer device 310 and the attribute input device 142. The attribute input device 142 is described above with reference to FIG. 2, and may include the same or a different attribute input device 142 than the one used to capture the user attribute information 122. Thus, the user attribute device 142 may be selected from the group consisting of: a camera executing by the reviewer device 310, a camera executing by a reviewer mobile computing device, a three-dimensional profiling device, and a three-dimensional motion device.

In some implementations, the attribute service 152 receives reviewer attribute information 322 from the reviewer interface 314 through the network 130. The reviewer attribute information 322 corresponds to the reviewer 104 creating the product review 320 for the product or service. In some examples, the reviewer attribute information 322 is captured by the attribute input device 142 in the same manner as the user attribute information 122 is captured, as described above with reference to FIG. 2. In other examples, the reviewer attribute information 322 is manually input to the reviewer device 310 by the reviewer 104 and transmitted to the attribute service 152. The attribute service 152 may obtain reviewer physical attributes 324 for the reviewer 104 based on the reviewer attribute information 322 received from the reviewer interface 314. In some examples, the reviewer physical attributes 324 are stored within the data storage 176 and retrieved by the attribute service 152 using the reviewer attribute information 322. For instance, the attribute service 152 may use classifiers or template matching to identify the reviewer physical attributes 324 stored within the data storage 176 that correspond to the reviewer attribute information 322. In other examples, the attribute service 152 generates the reviewer physical attributes 324 by processing the reviewer attribute information 322 upon being received. Thereafter, the attribute service 152 may provide the reviewer physical attributes 324 to the associative service 154.

In some implementations, the associative service 154 receives the product review 320 from the reviewer 104. The product review 320 may include an item identifier 242 identifying the product or service being reviewed by the reviewer 104. The associative service 154 may receive the product review 320 from the reviewer device 310 and the reviewer physical attributes 324 simultaneously. In some implementations, the associative service 154 associates the product review 320 with the reviewer physical attributes 324 for the reviewer 104 and stores the product review 320 associated with the reviewer physical attributes 324 in the data storage 172.

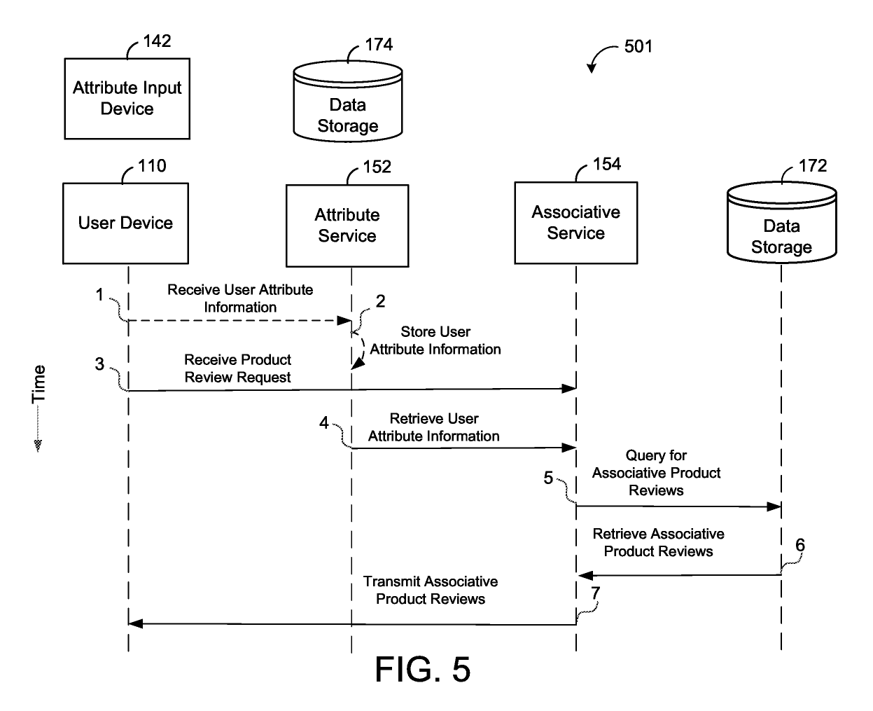

FIG. 5 is a diagram 501 illustrating example operations performed by the review service 150 of the system 100 of FIG. 2 when a product review request 240 is received from the user device 110. The vertical y-axis indicates time increasing from the top to the bottom. At time 1, the user interface 114 executing on the user device 102 and communicating with an attribute input device 142 transmits user attribute information 122 to the attribute service 152. In some examples, the attribute input device 142 captures the user attribute information 122. In other examples, the user 102 manually inputs the user attribute information 122 to the user device 110. The user attribute information 122 received by the attribute service 152 is stored in the data storage 174 at time 2. At time 3, the user device 110 requests product reviews to the associative service 154. In some examples, the user attribute information 122 and the product review request 240 are concurrently executed at the user interface 114 during the same transaction. In other examples, the user attribute information 122 is stored in data storage 174 during a prior transaction. The product review request 240 received at the associative service 154 includes an item identifier 242 identifying the product or service and a user identifier 120 identifying the user 102. At time 4, the associative service 154 retrieves the user attribute information 122 from the data storage 174 using the user identifier 120. At time 5, the associative service 154 queries product reviews 320 stored in the data storage 172 using the item identifier 242 and the user attribute information 122 to identify which product reviews 320 including the item identifier 242 are associated with reviewers 104 including reviewer physical attributes 324 matching the user attribute information 122. At time 6, the associative service 154 retrieves the associative product reviews 220 from the data storage 172. The associative product reviews 220 retrieved by the associative service 154 includes one or more of the product reviews 320 identified by the querying. At time 7, the associative service 154 transmits the associative product reviews 220 to the user device 110, wherein the user device 102 executing the software application 118 renders the associative product reviews 220 for display upon the user interface 114 (e.g., graphical user interface) executing on the user device 110.

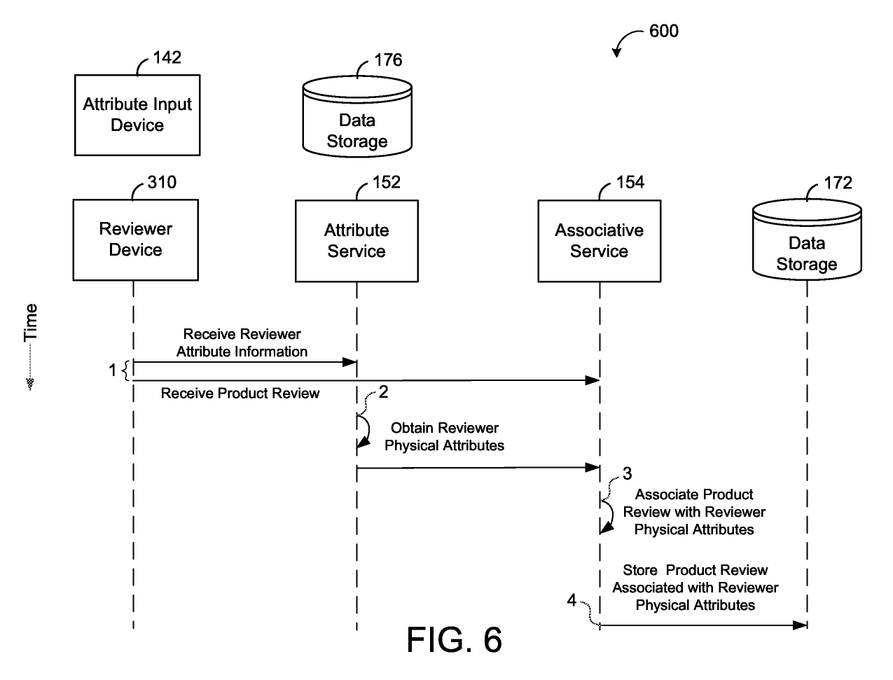

FIG. 6 is a diagram 600 illustrating example operations performed by the review service 150 of FIG. 4 when a product review 320 is received from the reviewer device 310. The vertical y-axis indicates time increasing from the top to the bottom. At time 1, the reviewer device 310 (executing the reviewer interface 314) inputs reviewer attribute information 322 to the attribute service 152 and inputs a product review 320 to the associative service 154. The product review 320 received at the associative service 154 includes an item identifier 242 identifying the particular product being reviewed. The reviewer attribute information 322 received at the attribute service 154 may be captured by an attribute input device 142 or the reviewer attribute information 322 may be manually input to the reviewer device 310 by the reviewer 104. The attribute input device 142 communicates with the reviewer interface 314 executing on the reviewer device 310. The reviewer attribute information 322 corresponds to the reviewer 104 creating the product review 320. At time 2, the associative service 154 obtains reviewer physical attributes 324 for the reviewer 104 based on the reviewer attribute information 322 received from the reviewer interface 314. In some examples, the reviewer physical attributes 324 are stored within the data storage 176 and retrieved by the attribute service 152, via classifiers or template matching, using the reviewer attribute information 322. In other examples, the attribute service 152 generates the reviewer physical attributes 324 by processing the reviewer attribute information 322 upon being received. The attribute service 152 communicates with the associative service 154 and provides the reviewer physical attributes 324 to the associative service 154. At time 3, the associative service 154 associates the product review 320 with the reviewer physical attributes 324 obtained for the reviewer 104 and stores the product review 320 associated with the reviewer physical attributes 324 in the data storage 172 at time 4.

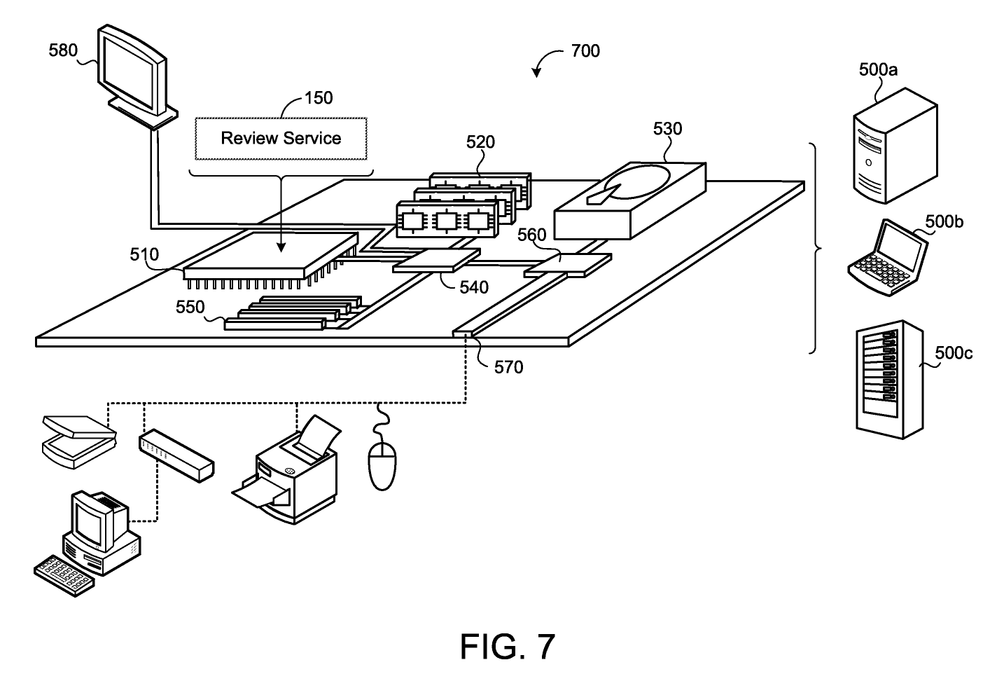

FIG. 7 is schematic view of an example computing device 700 that may be used to implement the systems and methods described in this document, such as the review service 150, the user device 110, and the reviewer device 310. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 510, memory 520, a storage device 530, a high-speed interface/controller 540 connecting to the memory 520 and high-speed expansion ports 550, and a low speed interface/controller 560 connecting to low speed bus 570 and storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and low-speed expansion port 570. The low-speed expansion port 570, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

In some implementations, the computing device 700 implementing the review service 150 is in communication with data storage 170, 172, 174 and 176 (e.g., in the memory 520). The processor 510 executes the review service 150 including the attribute service 152 and the associative service 154. For example, the review service 150 (executing on the processor 510) receives a product review request 240 from the user device 102, obtains user attribute information 122 indicating one or more user physical attributes of the user 102, retrieves one or more associative product reviews 220 for the product from data storage 172 and transmits the one or more associative product reviews 220 to the user device 102.

In some implementations, the attribute service 152 executing on the review service 150 receives and stores the user attribute information 122 in the data storage 174. In some examples, the attribute service 152 receives the user attribute information 122 from an attribute input device 142 in communication with a user interface 114 executing on the user device 102. In some examples, the attribute service 152 receives the user attribute information 122 from the user device 102 when the user 102 manually inputs the user attribute information 122 to the user device 102.

In some implementations, the associative service 154 executing on the review service 150 receives the product review request 240, an item identifier 242 identifying particular the product or service, and a user identifier 120 from the user device 102 and retrieves the user attribute information 122 from the data storage 174 using the user identifier 120. In some examples, the associative service 154 queries product reviews 320 stored in the data storage 172 using the item identifier 242 and the user attribute information 122 to identify which product reviews 320 including the item identifier 242 are associated with reviewers 104 including the reviewer physical attributes 324 matching the user physical attributes (e.g., the user attribute information 122). The associative service 154 may retrieve the associative product reviews 220 from the data storage 172, the associative product reviews 220 including the product reviews 320 identified by the querying.

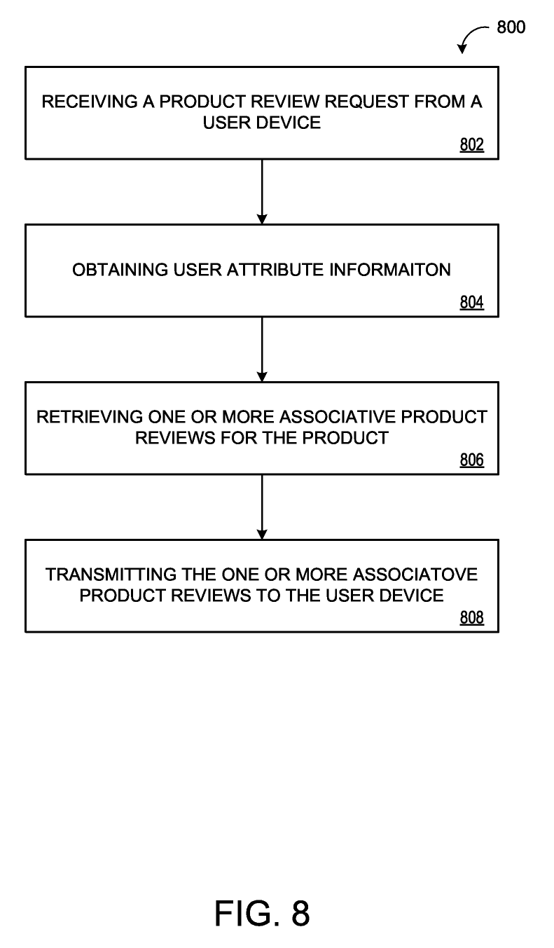

FIG. 8 is a flowchart of an example method 800 executed by the computing device 700 of FIG. 7 for transmitting associative product reviews 220 to the user device 102 based on user attribute information 122 and a product review request 240 from the user device 102. The flowchart starts at operation 802 where an associative service 154 receives a product review request 240 from a user device 102 to obtain one or more product reviews for a product being offered for sale by a retailer, as illustrated in FIG. 5 at time 3. In some examples, the product review request 240 includes an item identifier 242 identifying the particular product or service. In some examples, the associative service 154 receives a user identifier 120 included with the product review request 240. At operation 804, the associative service 154 obtains user attribute information 122 indicating one or more user physical attributes of the user 102. In some examples, an attribute service 152 receives the user attribute information 122 from the user device 102 when the associative service 154 receives the product review request 240, wherein the user attribute information 122 is manually input to the user device 110 by the user 102, as illustrated in FIG. 5 at time 1. In some examples, the attribute service 152 receives the user attribute information 122 from an attribute input device 142 when the associative service 154 receives the product review request 240, wherein the user attribute device 142 captures the user attribute information 122 from the user 102, as illustrated in FIG. 5 at time 1. The attribute service 152 may store the received user attribute information 122 in non-transitory data storage 174 in communication with the attribute service 152. In some implementations, the associative service 154 retrieves the user attribute information 122 from the data storage 174 using the user identifier 120, as illustrated in FIG. 5 at time 4.

At operation 806, the associative service 154 retrieves one or more associative product reviews 220 for the product or service from non-transitory data storage 172 in communication with the associative service 154 based on the product review request 240 and the user attribute information 122. In some examples, the associative service 154 queries product reviews 320 stored in the data storage 172 using the item identifier 242 and the user attribute information 122 to identify which product reviews 320 including the item identifier 242 are associated with reviewers 104 including reviewer physical attributes 324 matching the user attribute information 122, as illustrated in FIG. 5 at time 5. In some examples, the associative service 154 retrieves the associative product reviews 220 from the data storage 170, as illustrated in FIG. 5 at time 6. The associative product reviews 220 retrieved by the associative service 154 includes the product reviews 320 identified by the querying. At operation 808, the associative service 154 transmits the one or more associative product reviews 220 retrieved from the data storage 172 to the user device 102, as illustrated in FIG. 5 at time 7. In some examples, the associative product reviews 220 transmitted from the associative service 154 prompts an application 118 executing on the user device 102 to render the associative product reviews 102 for display upon a user interface 114 executing on the user device 102, the associative product reviews displayed upon the user interface indicating to the user 102 the one or more associative product reviews 220.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at a review computing device, a product review request from a user device to obtain one or more product reviews for a product or service being offered for sale by a retailer, the product review request comprising an item identifier identifying the product or service;
obtaining, by the review computing device, user attribute information indicating one or more user physical attributes of the user;
retrieving, by the review computing device, one or more associative product reviews for the product from non-transitory data storage in communication with the review computing device based on the product review request and the user attribute information; and
transmitting the one or more associative product reviews from the review computing device to the user device.

2. The method of claim 1, wherein each associative product review comprises the item identifier and is associated with a reviewer comprising reviewer physical attributes matching the user physical attributes.

3. The method of claim 1, further comprising receiving, at the review computing device, the user attribute information from the user device when the product review request is received, the user attribute information being manually input to the user device by the user.

4. The method of claim 1, further comprising receiving, at the review computing device, the user attribute information from an attribute input device when the product review request is received, the attribute input device capturing the user attribute information from the user.

5. The method of claim 4, wherein the attribute input device is selected from the group consisting of: a camera executing on the user device, a three-dimensional profiling device, and a three-dimensional motion device.

6. The method of claim 1, further comprising:
receiving, at the review computing device, a user identifier included with the product review request; and
retrieving, using the review computing device, the user attribute information from the data storage using the user identifier.

7. The method of claim 6, further comprising:
prior to receiving the product review request:
receiving, at the review computing device, the user attribute information from an attribute input device, wherein the user attribute information is captured by the attribute input device; and
storing, using the review computing device, the user attribute information in the data storage.

8. The method of claim 1, further comprising:
querying, using the review computing device, product reviews stored in the data storage using the item identifier and the user attribute information to identify which product reviews comprising the item identifier are associated with reviewers comprising reviewer physical attributes matching the user physical attributes; and
retrieving, using the review computing device, the associative product reviews from the data storage, the associative product reviews comprising the product reviews identified by the querying.

9. The method of claim 1, further comprising:
receiving, at the review computing device, a product review from a reviewer device, the product review comprising an item identifier identifying the product or service being reviewed;
receiving, at the review computing device, reviewer attribute information from an attribute input device, the reviewer attribute information corresponding to the reviewer creating the product review;
obtaining, at the review computing device, reviewer physical attributes for the reviewer based on the reviewer attribute information;
associating, using the review computing device, the product review with the reviewer physical attributes obtained for the reviewer; and
storing, using the product review computing device, the associated product review in the data storage.

10. The method of claim 9, wherein the attribute input device includes at least one of a camera executing by the user device, a three-dimensional profiling device, or a three-dimensional motion device.

11. The method of claim 1, wherein the user physical attributes correspond to one or more static-based measurements associated with one or more body portions of the user.

12. The method of claim 1, wherein the user physical attributes correspond to one or more motion-based measurements associated with a prescribed movement of the user.

13. The method of claim 1, further comprising prior to retrieving the one or more associative product reviews, identifying, by the review computing device, the user attribute information as being relevant to the product associated with the product review request.

14. The method of claim 1, further comprising after obtaining the user attribute information:
receiving, at the review computing device, updated user attribute information from the user device, the updated user attribute information indicating at least one of a new value or a range of values for the previously obtained user attribute information;
retrieving, by the review computing device, one or more updated associative product reviews for the product from the data storage based on the product review request and the updated user attribute information; and
transmitting the one or more updated associative product reviews from the review computing device to the user device.

15. The method of claim 1, wherein the associative product reviews transmitted from the review computing device prompts an application executing on the user device to render the associative product reviews for display upon a user interface executing on the user device.

16. A remote system comprising:
one or more associative processing devices executing an associative service, the associative service:
receiving a product review request from a user device to obtain one or more product reviews for a product or service being offered for sale by a retailer, the product review request comprising an item identifier identifying the product or service;
obtaining user attribute information indicating one or more user physical attributes of the user;
retrieving, by the review computing device, one or more associative product reviews for the product or service from non-transitory data storage in communication with the computing device based on the product review request and the user attribute information; and
transmitting the one or more associative product reviews from the review computing device to the user device.

17. The system of claim 16, wherein each associative product review comprises the item identifier and is associated with a reviewer comprising reviewer physical attributes matching the user physical attributes.

18. The system of claim 16, further comprising one or more attribute processing devices in communication with the one or more associative processing devices and executing an attribute service, the attribute service:
receiving the user attribute information from the user device when the product review request is received at the one or more associative processing devices, the user attribute information being manually input to the user device by the user.

19. The system of claim 16, further comprising one or more attribute processing devices in communication with the one or more associative processing devices and executing an attribute service, the attribute service:
receiving the user attribute information from an attribute input device when the product review request is received at the the one or more associative processing devices, the attribute input device capturing the user attribute information from the user.

20. The system of claim 19, wherein the attribute input device is selected from the group consisting of: a camera executing on the user device, a three-dimensional profiling device, and a three-dimensional motion device.

21. The system of claim 16, wherein the associative service, at the one or more associative processing devices:
receives a user identifier included with the product review request; and
retrieves the user attribute information from the data storage using the user identifier.

22. The system of claim 21, further comprising one or more attribute processing devices in communication with the one or more associative processing devices and executing an attribute service, the attribute service, prior to the one or more associative processing devices receiving the product review request:
receiving the user attribute information from an attribute input device, wherein the user attribute information is captured by the attribute input device; and
storing the user attribute information in the data storage.

23. The system of claim 16, wherein the associative service, at the one or more associative processing devices:
queries product reviews stored in the data storage using the item identifier and the user attribute information to identify which product reviews comprising the item identifier are associated with reviewers comprising reviewer physical attributes matching the user physical attributes; and
retrieves the associative product reviews from the data storage, the associative product reviews comprising the product reviews identified by the query.

24. The system of claim 16, further comprising one or more attribute processing devices in communication with the one or more associative processing devices and executing an attribute service, the attribute service:
receiving reviewer attribute information from an attribute input device, the reviewer attribute information corresponding to the reviewer creating the product review; and
wherein the associative service, at the one or more associative processing devices:
receives a product review from a reviewer device, the product review comprising an item identifier identifying the product or service being reviewed;
obtains reviewer physical attributes for the reviewer based on the reviewer attribute information;
associates the product review with the reviewer physical attributes obtained for the reviewer; and
stores the associated product review in the data storage.

25. The system of claim 24, wherein the attribute input device includes at least one of a camera executing on the user device, a three-dimensional profiling device, or a three-dimensional motion device.

26. The system of claim 16, wherein the user physical attributes correspond to one or more static-based measurements associated with one or more body portions of the user.

27. The system of claim 16, wherein the user physical attributes correspond to one or more motion-based measurements associated with a prescribed movement of the user.

28. The system of claim 16, wherein prior to retrieving the one or more associative product reviews for the product or service, the associative service, at the one or more associative processing devices:
identifies the user attribute information as being relevant to the product or service associated with the product review request.

29. The system of claim 16, wherein after obtaining the user attribute information, the associative service, at the one or more associative processing devices:
receives updated user attribute information from the user device indicating at least one of a new value or a range of values for the previously obtained user attribute information;
retrieves one or more updated associative product reviews for the product from the data storage based on the product review request and the updated user attribute information; and
transmits the one or more updated associative product reviews from the review computing device to the user device.

30. The system of claim 16, wherein the associative product reviews transmitted from the one or more associative processing devices to the user device prompts an application executing on the user device to render the associative product reviews for display upon a user interface executing on the user device.
